(19) United States
(12) Patent Application Publication
(10) Pub. No.: US 2007/0199400 A1
(43) Pub. Date: Aug. 30, 2007

(54) Actuation lever system with breakaway element and simple assembly

(76) Inventor: Kennith Hall, Torrance, CA (US)

Correspondence Address: PATENT LAW & VENTURE GROUP, 2424 S.E. BRISTOL, SUITE 300, NEWPORT BEACH, CA, 92660, US

(21) Appl. No.: 11/357,836

(22) Filed: Feb. 16, 2006

(51) Int. Cl. F16C 1/10

(52) U.S. Cl. 74/502.2

(57) ABSTRACT

A breakaway control lever apparatus has a lever arm providing an aperture. A separable load-transmitting element provides a first portion engaging the lever arm aperture and extending therefrom in rotational engagement with a shaft. A fixture provides a clamping portion, a cable engaging portion and a further portion engaging the load-transmitting element and the shaft. A cable provides a cable termination engaging the lever arm aperture and a groove in the first portion of the load-transmitting element thereby securing the load-transmitting element within the lever arm. Upon receiving an impact, the load-transmitting element will tend to fracture before the lever arm.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### REFERENCE TO A “MICROFICHE APPENDIX”

Not applicable.

### BACKGROUND OF THE INVENTION

1. Field of the Present Disclosure

This disclosure relates generally to cable actuating lever arms and more particularly to such a lever arm assembly with a break-away feature and having a simplified assembly to make replacement of the break-away feature simple and quick.

2. Description of Related Art Including Information Disclosed Under 37 CFR 1.97 and 1.98

Tsumiyama et al., U.S. Pat. No. 6,691,591, discloses a bicycle control device having a control lever that is operable in a first direction to operate the brake control mechanism, a second direction to operate the shift control mechanism in the pulling direction and a third direction to operate the shift control mechanism in the release direction. In a preferred embodiment of the invention, when viewed from the perspective of a rider on the bicycle, the first direction is the direction of movement of the lever toward the handlebar. The second direction is the direction of movement of the control lever downward and the third direction is the direction of movement of the control lever upward. In a more preferred embodiment, the second and third directions are perpendicular to the first direction. Nishimura et al., U.S. Pat. No. 6,584,870, discloses a shift lever device having a shift lever which allows selection of an arbitrary shift range by shift operation and includes a support which rotatably supports the shift lever and includes breakable portions which break when an impact force above a pre-selected magnitude is applied to the shift lever. Accordingly, when an axial impact force indicative of a sudden deceleration is applied to the shift lever, the support is broken. The breakage of the support allows safer absorption of the impact force applied to the shift lever. The breakable portions may take the form of a frangible pin or bracket that pivotally supports the shift lever. Barnett U.S. Pat. No. 6,578,445, discloses a collapsible control lever suitable for use on a motorcycle, the control lever including a handlebar mount, an intermediate section and a lever section. The intermediate section and lever section are capable of rotation with respect to the handlebar mount between a relaxed position and an actuated position in order to provide control lever functions, such as disengaging a manual clutch. The lever section is capable of rotation with respect to the intermediate section between a normal position and a fully deflected position in order to avoid damage in the event of the motorcycle overturning. The lever section may be biased to its normal position. Barnett, U.S. Pat. No. 6,393,936, discloses a collapsible control lever suitable for use on a motorcycle, the control lever including a handlebar mount, an intermediate section and a lever section. The intermediate section and lever section are capable of rotation with respect to the handlebar mount between a relaxed position and an actuated position in order to provide control lever functions, such as disengaging a manual clutch. The lever section is capable of rotation with respect to the intermediate section between a normal position and a fully deflected position in order to avoid damage in the event of the motorcycle overturning. The lever section may be biased to its normal position. Vos, U.S. Pat. No. 6,098,488, discloses a brake lever for a cycle including a brake handle having a crank beam pivotally coupled to a lever bracket at a pivot shaft, an adjuster nut rotatably received in the brake handle and extended outward of the brake handle so as to be rotated by the user. A bar has one end pivotally coupled to the crank beam at a pivot pin and has a cable link pivotally coupled to the other end. A bolt is threaded through the adjuster nut and has one end pivotally coupled to the bar for rotating the bar about the pivot pin and for adjusting the brake lever to different brake leverages. Chien, U.S. Pat. No. 6,098,487, discloses a hand brake that includes a mounting frame mounted on a handlebar grip of a wheeled walker and defining a working space with an open side and a closed end wall. A cable pull block is disposed inside the working space, and has an upper part pivoted to the mounting frame by a first pivot, and a lower part serving as a force bearing part and connected to a transmission cable under tension. A control lever has a pivot part extending into the working space via the open side thereof, and an operating part extending outwardly of the working space. The pivot part has an upper portion that is provided with an upwardly opening accommodating space. The accommodating space has a base wall. The cable pull block extends downwardly into the accommodating space such that the lower part confronts the base wall. The lower part of the control lever is pivoted to the cable pull block by a second pivot parallel to and disposed below the first pivot. The control lever is operable from a non-braking state to a braking state, where the cable pull block is pivoted by the control lever about the first pivot to apply a pulling force to the transmission cable. Warren et al., U.S. Pat. No. 6,047,611, discloses a collapsible control lever for use with a control system having levers including a conventional cable control lever system such as those found on motorcycles and bicycles. The lever has three independent axes of rotation about which sections of the lever rotate during impact to deflect the impact force. However, the lever remains rigid in the direction of the applied control force when in its operational position during normal operation. The lever restores itself to its operational position following impact with minimal user assistance. The lever may be sized and shaped to be easily retrofit into existing known pivot bases, and at least one of the pivots may include an improved swivel pivot that is sealed from mud and other debris in its operational configuration. The improved swivel pivot has a first and second generally cylindrical frame portion that rotate about a pivot pin with each frame portion having a sliding surface with a smoothly alternating concave and convex-shaped sliding surface. The two surfaces are in intermeshed alignment when the lever is in its operational configuration. The two surfaces slide out of intermeshed alignment during impact. A coil spring received within the frame portions urges the two frame portions toward each other and the misaligned concave and convex surfaces urge the frame portions to rotate to restore the sliding surfaces into intermeshed alignment following an impact. Nagano, U.S. Pat. No. 5,979,266, discloses a brake control apparatus for a bicycle. The apparatus has a control lever operatively connected with a control cable for pulling the cable and a force transmission ratio adjuster mechanism for adjusting a force transmission ratio in association with an operation of the control lever. The force transmission ratio is defined as a ratio obtained by dividing an output force from the cable associated with application of a unit input force to a certain lever position of the control lever. With the apparatus of the invention, this force transmission ratio is so determined as to have a maximum value at a position during an entire stroke of the lever between a stroke start end and a stroke finish end and the maximum value position is on the side of the finish end after a play stroke on the side of the start end. Scura, U.S. Pat. No. 5,287,765, discloses a hand actuated link cable or piston displacement system utilizing a four-bar linkage system attached to a hand-operated lever. The four-bar linkage system is connected by bolts that permit pivotal movement and enable the hand-operated lever to move with little or no longitudinal travel relative to the longitudinal axis of displacement. Adjustments to the lever's angle of operation can be made, as well as adjustments to the power ratio of the system, for applying force. Hornady, U.S. Pat. No. 4,730,509, discloses a control lever for motorcycle handlebars and the like having a dislocating pivot. A cable connected to the lever transmits a controlling force to a brake, clutch, or other machine. The pivot is a two-pronged fork element and a central element pivotally connected at a pair of joints, one joint for each prong of the fork element. A joint is a cylindrical rod with a hemispherical or other shaped end, and a socket with a cavity shape suitable to the rod end. A spring pushes a rod into engagement within a socket. A lip partially around the opening of the cavity defines the range of allowable twisting motion of the lever arm. When the lever is forced out of the direction of its normal motion, the pivot elements dislocate, preventing damage to the lever. The force required for dislocation depends on the spring bias against the rod, the shape of rod end, and the depth of the socket cavity. Myers, U.S. Pat. No. 4,391,160, discloses a support assembly for a control lever on a cycle handle bar which includes a mounting releasably locked in place by a spring-biased indent-detent mechanism. The mounting is releasable with a jarring force exerted on it to permit displacement circumferentially and axially on the bar. The assembly also includes a sleeve encircling and securable to the bar and a collar integral with the sleeve to prohibit axial movement of the mounting in one direction. A base portion in the mounting encircles the sleeve and a post used in mounting a control lever, projects laterally from the base portion. Barnett, 2005/0204847, discloses a control lever mount assembly suitable for use in connection with an off-road motorcycle. The lever mount assembly includes a lever-supporting portion, or perch, which is configured to rotatably support a control lever. A sleeve is secured to the handlebar and supports the perch for rotation about an axis of the handlebar. A detent assembly secures the perch in a desired angular orientation relative to the sleeve and the handlebar. The detent assembly is configured to permit rotation of the perch in response to a force being imparted to the lever and/or perch during a crash or fall to protect the perch and lever from damage. Preferably, one or more clamp members are configured to apply a clamping force to the sleeve over a relatively large surface area to prevent damage to the handlebar. A slot may be provided in the sleeve to permit the sleeve to be compressed around the handlebar for a secure fit. Spaizar et al., WO 03/031254, discloses a motorcycle control lever including a flexible portion that absorbs force and/or energy of an impact, preventing or reducing damage to a rigid part thereof. Barnett, WO 03/047954, disclose a control lever for operating a control system of a vehicle, such as a brake or clutch of a motorcycle, for example. The lever is especially useful with hydraulic control systems, for applying a force to a hydraulic piston of the control system. Preferably, the lever includes an engagement portion that contacts an end surface of the piston. The engagement portion may be free to rotate with respect to a body portion of the lever such that the engagement portion rolls across the end surface of the piston. Such an arrangement provides improved lever “feel” and substantially prevents transverse loading of the piston. In an alternative arrangement, the engagement portion may include a protruding arm that engages the end surface of the piston, for use with hydraulic control systems where the piston is recessed within a housing. Hideo, JP 03/021583, discloses an apparatus meant to prevent breakage of an operational lever in the event of fall-down by interposing a spring-energized bearing between an accommodation part, which is formed at a seat ring part in the necessary part of a handle bar, and a supporting part formed at a bracket of the operational lever. Hideo, JP 04/133891, discloses an apparatus meant to prevent breakage of a hand lever by elastically holding a holder part through elastic force of a bracket even at fully screwing vise for tightening the bracket to the holder part of a lever body, and allowing rotation of the lever body at applying large shock on the hand lever.

The related art described above discloses a variety of actuation lever systems for manually actuating a device by cable. Such lever systems are applied to a wide range of applications including brake, clutch and gear changing systems on bicycles, motorcycles and similar apparatus. It is also well known that such systems may be complex and expensive to replace when damaged. It is because of this cost and the high probability of damage due to the exposed positions of such systems that solutions to limit such damage are found in the art. However, the prior art fails to disclose a simplified lever system with a frangible element feature that is simple to assemble and inexpensive to replace. The present disclosure distinguishes over the prior art in several ways including by providing heretofore unknown advantages as described in the following summary.

### BRIEF SUMMARY OF THE INVENTION

This disclosure teaches certain benefits in construction and use which give rise to the objectives described below.

Because lever arms or handles for motorcycles and bicycles are made of relatively expensive materials and with relatively expensive manufacturing processes, and because such handles are subject to impacts because they are exposed on handle bars, it is valuable to provide a breakaway element that will fracture before the handle does in an accident. In this way the lever arm may continue to be used while replacing only a minor and inexpensive connector part. This is accomplished in the present apparatus where a breakaway control lever assembly has a lever arm with an aperture. A separable load-transmitting element provides a first portion engaging the lever arm aperture and extending therefrom in rotational engagement with a shaft. A fixture provides a clamping portion, a cable engaging portion and a further portion engaging the load-transmitting element and the shaft. A cable provides a cable termination engaging the lever arm aperture and a groove in the first portion of the load-transmitting element thereby securing the load-transmitting element within the lever arm. Upon receiving an impact, the load-transmitting element will tend to fracture before the lever arm.

A primary objective inherent in the above described apparatus and method of use is to provide advantages not taught by the prior art.

Another objective is to provide a lever arm assembly capable of sustaining in impact without fracturing the lever arm, but rather a sacrificial element of the assembly.

A further objective is to enable replacement of the sacrificial element quickly and with only a screwdriver or without any tools.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of the presently described apparatus;

FIG. 2 is a perspective view thereof showing elements of the apparatus separated.

FIGS. 3-5 are perspective views thereof showing a sequence of assembly;

FIGS. 4 and 5 are perspective view thereof showing assembly of an embodiment of the apparatus wherein key elements are engaged at an angle with respect to a handle arm of the apparatus.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present apparatus and method of use.

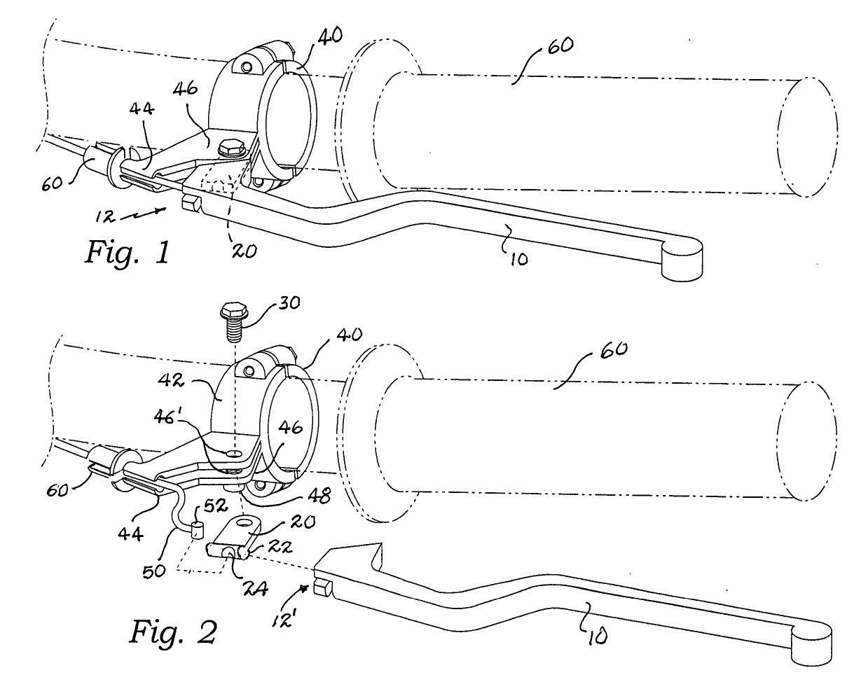

Described now in detail, and as shown in exemplary FIGS. 1 and 2, is a breakaway control lever apparatus including a lever arm 10 providing an aperture 12 therein, a separable load-transmitting element 20 providing a first portion 22 engaging the lever arm aperture 12 and extending therefrom in rotational engagement with a shaft 30 which is preferably the threaded portion of a screw as shown in FIG. 2. The lever arm 10 is preferably made of a lightweight metal or plastic material, most preferably cast aluminum or titanium. The load-transmitting element 20 is preferably made of a plastic material. A fixture 40 provides a clamping portion 42, preferably a circular clamp as shown, but which may be any type of clamping system known in the art. Fixture 40 further provides a cable engaging portion 44 as shown that holds a cable 50 within but does not grip it so that the cable 50 is able to slide freely within the cable engaging portion 44. The fixture 40 provides a further portion 46 engaging the load-transmitting element 20 and the shaft 30. This arrangement is as shown best in FIG. 1 wherein through hole 26 in the element 20 is engaged by the shaft 30 and held in rotational engagement within holes 46′ in portion 46 of fixture 40. As shown in FIG. 2, a nut 48, fixed to portion 46 in alignment with holes 46′, is used to capture and hold shaft 30 by threaded engagement. Any other fastening device may be substituted for this arrangement. The cable 50 provides a cable termination 52 well known in the art and in common use; a barrel shaped element. The cable termination 52 engages the lever arm aperture 12′, which, from the side is shaped like a keyhole with a circular portion for receiving the termination 52 and a narrow slot 12″ for accepting the cable 50. This is well known in the art and in common use as an engagement device. The narrow slot 12″ extends forward (to the proximal end) in the lever arm 10 so that the cable 50 may extend axially from the proximal end (the attachment end) of the lever arm 10 as is also well known in the art. The termination 52 engages a groove 24 in the first portion 22 of the load-transmitting element 20 thereby securing the load-transmitting element 20 within the lever arm 10. In this manner it may now been seen that with the cable engaged with the lever arm, the lever arm is integral with element 20, but by loosening the cable 50 by rotating cable securement nut 60, termination 52 may be removed from lever arm 10 and then lever arm 10 may be easily disassembled from element 20 for replacement of element 20 should it be broken in a fall or other mishap. A new element 20 may be installed by reversing the above steps. Clearly, the present system is simple, easy to use, inexpensive and convenient since one or more elements 20 may be carried easily in a pouch or saddle bag on the bicycle or motorcycle without taking up much room. Preferably, the lever arm aperture 12′ is aligned with the cable engaging portion 44 of the fixture 40 such that with the cable termination 52 engaged with the lever arm aperture 12′, the cable 50 may be directed within the cable engaging portion 44 of the fixture 40 and with nut 60 rotated as shown in FIG. 1, the cable 50 is captured within portion 44.

Preferably, the shaft 30 is a part of a fastener secured to the fixture 40 as shown in FIG. 1.

In the preferred embodiment, the clamping portion 42 of the fixture 40 is preferably sized to be secured to a handle bar 60 of a vehicle as shown in FIGS. 1 and 2.

By necessity, in order to meet the objectives of the present apparatus, the load-transmitting element 20 is made of a frangible material, such as a relatively fragile plastic, and certainly of a material that is more fragile than that of which the lever arm 10 is constructed so that in an impact, the element 20 will break before arm 10 thereby allowing arm 20 to survive severe impacts.

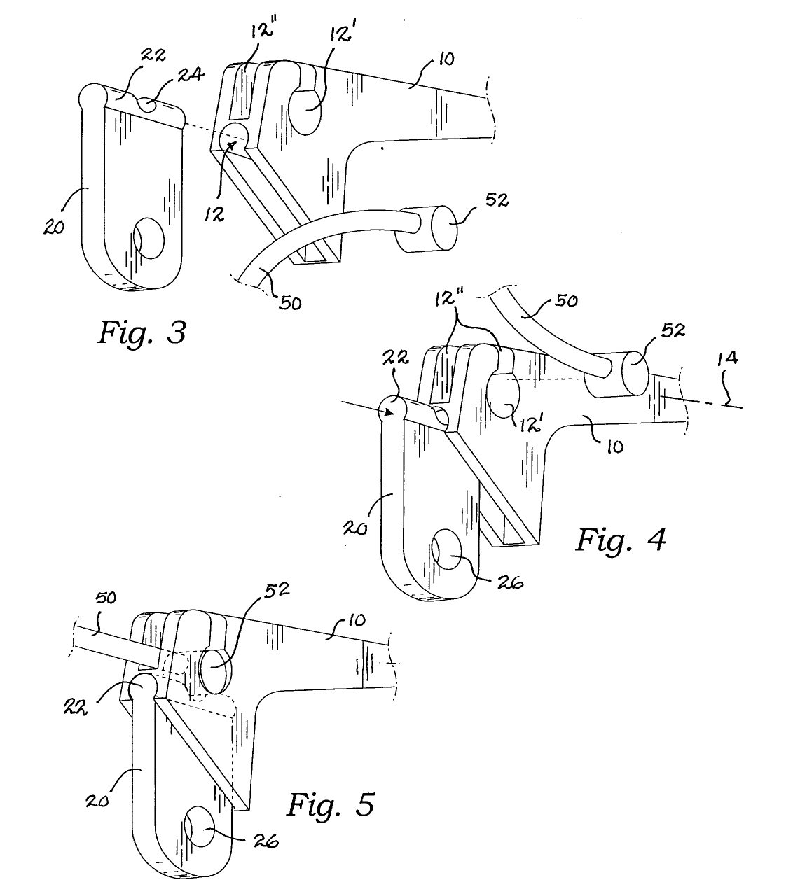

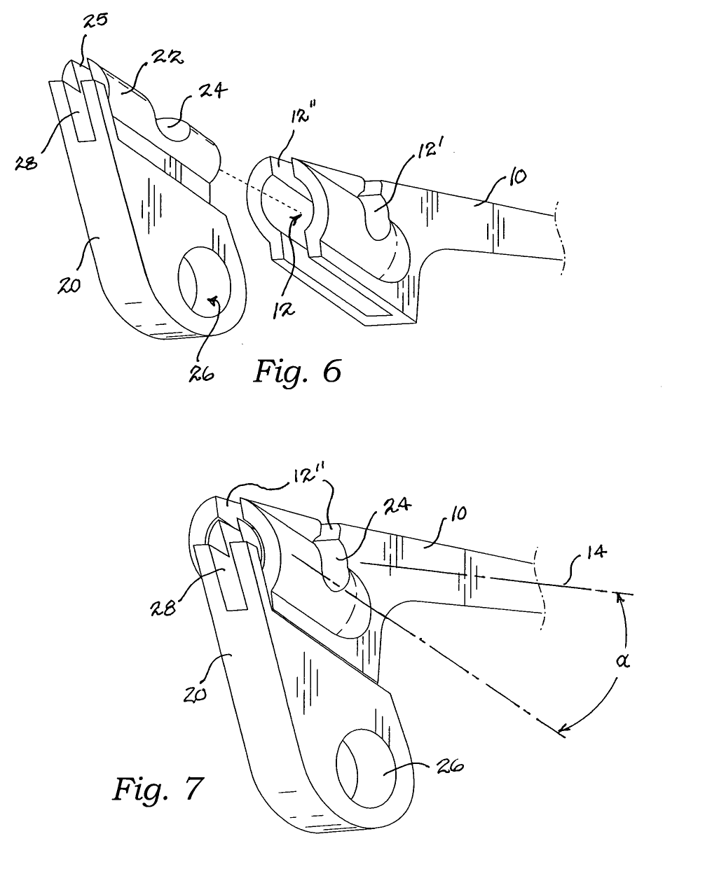

As shown in FIGS. 3-5, in a first embodiment of the present apparatus, the first portion 22 of the load-transmitting element 20 engages the lever arm aperture 12 by sliding therein with the aperture 12 directed essentially in the direction of the long axis 14 of the lever arm 10. This configuration is functional but not optimum as actuation of arm 10 rotating about hole 26 tends to disengage arm 10 from portion 22 since the direction of force between these two element is essentially in the direction of their engagement.

As shown in FIGS. 6 and 7, in a second embodiment of the present apparatus, the first portion 22 of the load-transmitting element 20 engages the lever arm aperture 12 by sliding therein as before, but the aperture 12 is directed essentially at a significant angle α such as between 30 and 45 degrees, with respect to the long axis 14 of the lever arm 10, such that the rotating force applied by the lever arm 10 to the load-transmitting element 20 is essentially orthogonal or near orthogonal to the direction of siding engagement of the load-transmitting element 20 into the lever arm aperture 12. Therefore, the action of lever 10 does not tend to disengage these two parts. Also, as shown in FIGS. 6 and 7, the first portion 22 of element 20 may be positioned at a more elevated position in lever arm 10 so that the cable 50 is engaged within slot 28 in element 20 as shown.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A breakaway control lever apparatus comprising: a lever arm providing an aperture therein; a separable load-transmitting element providing a first portion engaging the lever arm aperture and extending therefrom in rotational engagement with a shaft; a fixture providing a clamping portion, a cable engaging portion and a further portion engaging the load-transmitting element and the shaft; and a cable providing a cable termination, the cable termination engaging the lever arm aperture and a groove in the first portion of the load-transmitting element thereby securing the load-transmitting element within the lever arm.

2. The apparatus of claim 1 wherein the lever arm aperture is aligned with the cable engaging portion of the fixture such that with the cable termination engaged with the lever arm aperture, the cable lies within the cable engaging portion of the fixture.

3. The apparatus of claim 1 wherein the shaft is a part of a fastener secured to the fixture.

4. The apparatus of claim 1 wherein the clamping portion of the fixture is sized to be secured to a handle bar of a vehicle.

5. The apparatus of claim 1 wherein the load-transmitting element is made of a frangible material.

6. The apparatus of claim 1 wherein the load-transmitting element is made of a more frangible material than the material of which the lever arm is made.

7. The apparatus of claim 1 wherein the first portion of the load-transmitting element engages the lever arm aperture by sliding therein, the aperture directed essentially along the long axis of the lever arm.

8. The apparatus of claim 1 wherein the first portion of the load-transmitting element engages the lever arm aperture by sliding therein, the aperture directed at an angle with the long axis of the lever arm, such that a rotating force applied by the lever arm to the load-transmitting element is essentially orthogonal to the direction of siding of the load-transmitting element into the lever arm aperture.

9. A breakaway control lever apparatus comprising: a lever arm removably engaged with a separable load-transmitting element, the load-transmitting element rotationally engaged with a shaft; a fixture engaging the load-transmitting element and the shaft; and a cable terminating in engagement with the lever arm and a groove in the load-transmitting element thereby securing the load-transmitting element within the lever arm.

10. The apparatus of claim 9 wherein the cable extends from the lever arm through a cable engaging portion of the fixture such that with the cable termination engaged with the lever arm, the cable lies within the cable engaging portion of the fixture.

11. The apparatus of claim 9 wherein the shaft is a part of a fastener secured to the fixture.

12. The apparatus of claim 9 wherein the fixture is sized and configured to be secured to a handle bar of a vehicle.

13. The apparatus of claim 9 wherein the load-transmitting element is made of a frangible material.

14. The apparatus of claim 9 wherein the load-transmitting element is made of a more frangible material than the material of which the lever arm is made.

15. The apparatus of claim 9 wherein the load-transmitting element engages the lever arm by sliding therein in a direction essentially along the long axis of the lever arm.

16. The apparatus of claim 9 wherein the load-transmitting element engages the lever arm by sliding therein at an angle with the long axis of the lever arm, such that a rotating force applied by the lever arm to the load-transmitting element is essentially orthogonal to the direction of siding of the load-transmitting element into the lever arm.
